(19) United States
(12) Patent Application Publication
(10) Pub. No.: US 2013/0123438 A1
(43) Pub. Date: May 16, 2013

(54) Liquid Crystal Alignment Agent, Liquid Crystal Alignment Film Manufactured Using the Same, and Liquid Crystal Display Device Including the Liquid Crystal Alignment Film

(71) Applicants: Tae-Hyoung KWAK, Uiwang-si (KR); Bum-Jin LEE, Uiwang-si (KR); Jun-Seok KIM, Uiwang-si (KR); Won-Seok DONG, Uiwang-si (KR); Kyung-Soo MOON, Uiwang-si (KR); Hyo-Ju SEO, Uiwang-si (KR); Yo-Choul PARK, Uiwang-si (KR); Yong-Tak YANG, Uiwang-si (KR); Jung-Ah CHOI, Uiwang-si (KR)

(72) Inventors: Tae-Hyoung KWAK, Uiwang-si (KR); Bum-Jin LEE, Uiwang-si (KR); Jun-Seok KIM, Uiwang-si (KR); Won-Seok DONG, Uiwang-si (KR); Kyung-Soo MOON, Uiwang-si (KR); Hyo-Ju SEO, Uiwang-si (KR); Yo-Choul PARK, Uiwang-si (KR); Yong-Tak YANG, Uiwang-si (KR); Jung-Ah CHOI, Uiwang-si (KR)

(73) Assignee: CHEIL INDUSTRIES INC., Gumi-si (KR)

(21) Appl. No.: 13/571,484

(22) Filed: Aug. 10, 2012

(30) Foreign Application Priority Data
Nov. 11, 2011 (KR) 10-2011-0117647

(51) Int. Cl. C08L 79/08

(52) U.S. Cl. 525/432; 525/420

(57) ABSTRACT

Disclosed is a liquid crystal alignment agent that includes a polymer including a polyamic acid including a repeating unit represented by the following Chemical Formula 1, polyimide including a repeating unit represented by the following Chemical Formula 2, or a combination thereof, wherein in Chemical Formulas 1 and 2, X¹, X², Y¹ and Y² are the same as defined in the detailed description.

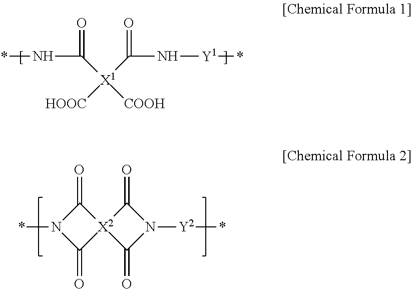

### CROSS-REFERENCE TO RELATED APPLICATION

This application claims priority to and the benefit of Korean Patent Application No. 10-2011-0117647 filed in the Korean Intellectual Property Office on Nov. 11, 2011, the entire disclosure of which is incorporated herein by reference.

### FIELD

This disclosure relates to a liquid crystal alignment agent, a liquid crystal alignment film manufactured using the same, and a liquid crystal display device including the liquid crystal alignment film.

### BACKGROUND

A liquid crystal display (LCD) device includes a liquid crystal alignment film, and the liquid crystal alignment film is mainly made of polymer materials. The liquid crystal alignment film plays a role of a director in aligning liquid crystal molecules and aligns the liquid crystal molecules in a predetermined direction, when the liquid crystal molecules are moved by the influence of an electric field to display an image. Generally, the liquid crystal molecules are uniformly aligned in order to provide LCDs with uniform brightness and a high contrast ratio.

There is an increasing demand for high quality LCDs. In addition, since LCDs are rapidly becoming larger, there is an increasing need for a highly productive liquid crystal alignment film. Accordingly, research has focused on a liquid crystal alignment agent capable of forming a liquid crystal alignment film having a low defect rate in the LCD manufacturing process, excellent electro-optical characteristics, high reliability, and high performance, which widely satisfies different characteristics for variously developing LCDs.

### SUMMARY OF THE INVENTION

One embodiment of the present invention provides a liquid crystal alignment agent capable of improving transmittance, response speeds, liquid crystal alignment properties, and electro-optical characteristics and easily controlling a pretilt angle.

Another embodiment of the present invention provides a liquid crystal alignment film manufactured using the liquid crystal alignment agent.

Yet another embodiment of the present invention provides a liquid crystal display device including the liquid crystal alignment film.

According to one embodiment of the present invention, provided is a liquid crystal alignment agent that includes a polymer including polyamic acid including a repeating unit represented by the following Chemical Formula 1, polyimide including a repeating unit represented by the following Chemical Formula 2, or a combination thereof.

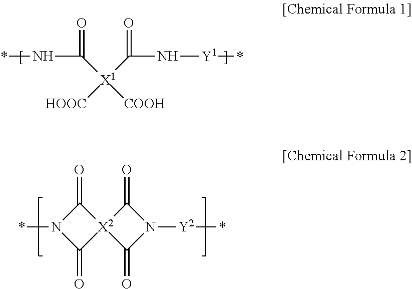

In Chemical Formulas 1 and 2,

X¹ and X² are the same or different and are each independently a tetravalent organic group derived from alicyclic acid dianhydride or aromatic acid dianhydride, and

Y¹ and Y² are the same or different and are each independently a divalent organic group derived from diamine, wherein the diamine includes at least one diamine represented by the following Chemical Formula 3 and at least one aromatic diamine represented by the following Chemical Formulas 4 to 7, or at least one functional diamine represented by the following Chemical Formulas 8 to 11, or both of at least one aromatic diamine represented by the following Chemical Formulas 4 to 7 and at least one functional diamine represented by the following Chemical Formulas 8 to 11.

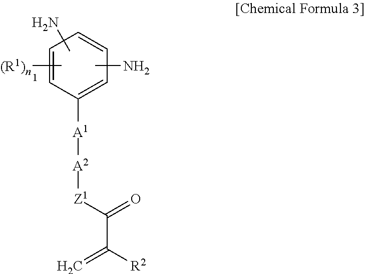

In Chemical Formula 3,

each R¹ is independently hydrogen, a substituted or unsubstituted C1 to C30 aliphatic organic group, or a substituted or unsubstituted C2 to C30 aromatic organic group,

n₁ is an integer ranging from 0 to 3,

A¹ is a divalent organic group represented by —O—, —C(O)O—, —N(H)—, —N(H)C(O)—, —C(O)N(H)—, or —OC(O)—,

A² is a single bond, a substituted or unsubstituted divalent C3 to C30 aliphatic organic group, a substituted or unsubstituted divalent C3 to C30 aromatic organic group, or a substituted or unsubstituted divalent C3 to C30 alicyclic organic group,

Z¹ is a single bond, oxygen (O), a substituted or unsubstituted divalent C1 to C20 aliphatic organic group, a substituted or unsubstituted divalent C2 to C30 aromatic organic group, or a substituted or unsubstituted divalent C3 to C30 alicyclic organic group, and

R² is hydrogen or methyl.

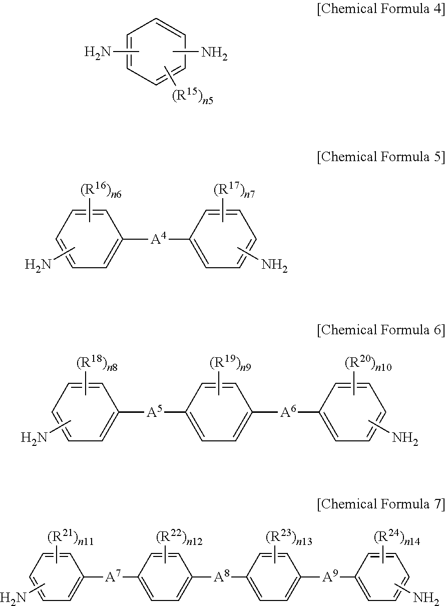

In Chemical Formulas 4 to 7,

R¹⁵ to R²⁴ are the same or different and are each independently hydrogen, a substituted or unsubstituted C1 to C30 aliphatic organic group, a substituted or unsubstituted C2 to C30 aromatic organic group, or a substituted or unsubstituted C3 to C30 alicyclic organic group, wherein the aliphatic organic group, alicyclic organic group, and aromatic organic group may further include —O—, —C(O)O—, —C(O)N(H)—, —OC(O)—, or a combination thereof,

A⁴ to A⁹ are the same or different and are each independently a single bond, —O—, —S(O)₂—, or —C(R¹⁰³)(R¹⁰⁴)—, wherein R¹⁰³ and R¹⁰⁴ are the same or different and are each independently hydrogen or substituted or unsubstituted C1 to C6 alkyl, and

n₅ to n₁₄ are each independently integers ranging from 0 to 4.

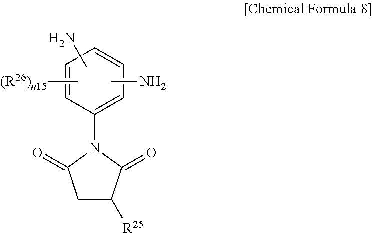

In Chemical Formula 8,

R²⁵ is hydrogen, a substituted or unsubstituted C1 to C30 aliphatic organic group, a substituted or unsubstituted C2 to C30 aromatic organic group, or a substituted or unsubstituted C3 to C30 alicyclic organic group,

each R²⁶ is the same or different and each is independently hydrogen, a substituted or unsubstituted C1 to C30 aliphatic organic group, a substituted or unsubstituted C2 to C30 aromatic organic group, or a substituted or unsubstituted C3 to C30 alicyclic organic group, and

n₁₅ is an integer ranging from 0 to 3.

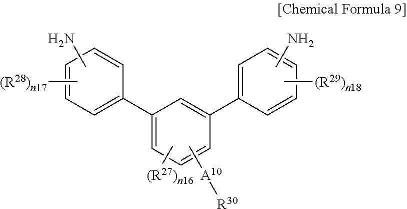

In Chemical Formula 9,

R²⁷, R²⁸, and R²⁹ are the same or different and are each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group,

A¹⁶ is a single bond, —O—, —C(O)O—, —C(O)N(H)—, —OC(O)—, or substituted or unsubstituted C1 to C10 alkylene,

R³⁰ is hydrogen, a substituted or unsubstituted C1 to C30 aliphatic organic group, a substituted or unsubstituted C2 to C30 aromatic organic group, or a substituted or unsubstituted C3 to C30 alicyclic organic group, wherein the aliphatic organic group, alicyclic organic group, and aromatic organic group may further include —O—, —C(O)O—, —C(O)N(H)—, —OC(O)—, or a combination thereof,

n₁₆ is an integer of 0 to 3, and

n₁₇ and n₁₈ are each independently an integer ranging from 0 to 4.

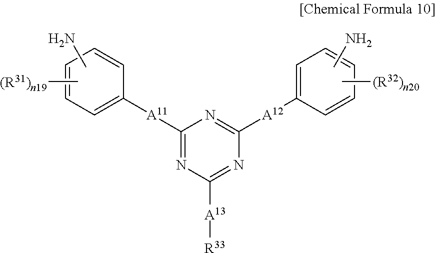

In Chemical Formula 10,

R³¹ and R³² are the same or different and are each independently hydrogen, a substituted or unsubstituted C1 to C30 aliphatic organic group, a substituted or unsubstituted C2 to C30 aromatic organic group, or a substituted or unsubstituted C3 to C30 alicyclic organic group,

n₁₉ and n₂₀ are each independently an integer ranging from 0 to 4,

R³³ is hydrogen, a substituted or unsubstituted C1 to C30 aliphatic organic group, a substituted or unsubstituted C2 to C30 aromatic organic group, or a substituted or unsubstituted C3 to C30 alicyclic organic group,

A¹¹ and A¹² are the same or different and are each independently a single bond, —O—, or —C(O)O—, and

A¹³ is a single bond, —O—, —C(O)O—, —C(O)N(H)—, or —OC(O)—.

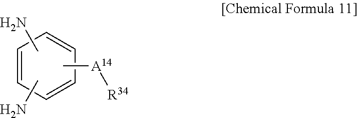

In Chemical Formula 11,

A₁₄ is a divalent organic group represented by —O—, —C(O)—, —C(O)O—, —N(H)—, —N(H)C(O)—, —C(O)N(H)—, —S—, or —OC(O)—, and

R³⁴ is hydrogen, a substituted or unsubstituted C1 to C40 aliphatic organic group, a substituted or unsubstituted C2 to C30 aromatic organic group, or a substituted or unsubstituted C1 to C30 alicyclic organic group.

The diamine represented by Chemical Formula 3 may be represented by the following Chemical Formulas 12, 13, 14, 15, 16, or a combination thereof.

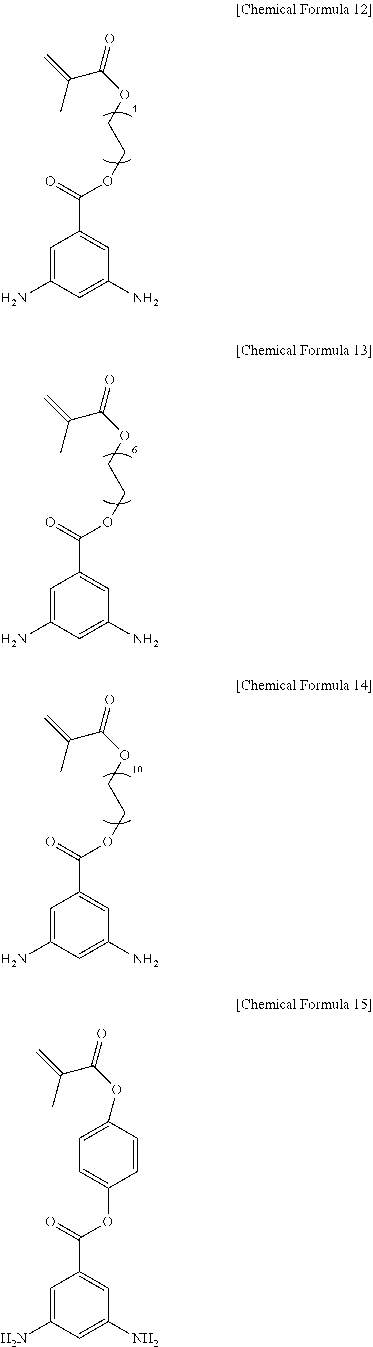

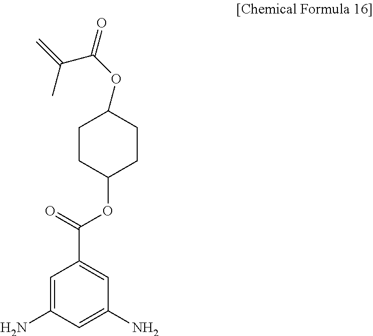 [SMILES: C=C(C)C(=O)OC1CCC(OC(=O)c2cc(N)cc(N)c2)CC1]

Examples of the aromatic diamine may include without limitation paraphenylenediamine (p-PDA), 4,4-methylene dianiline (MDA), 4,4-oxydianiline (ODA), metabisaminophenoxydiphenylsulfone (m-BAPS), parabisaminophenoxydiphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene, and the like, and combinations thereof.

The functional diamine may include a diamine represented by the following Chemical Formulas 17 to 20 or a combination thereof.

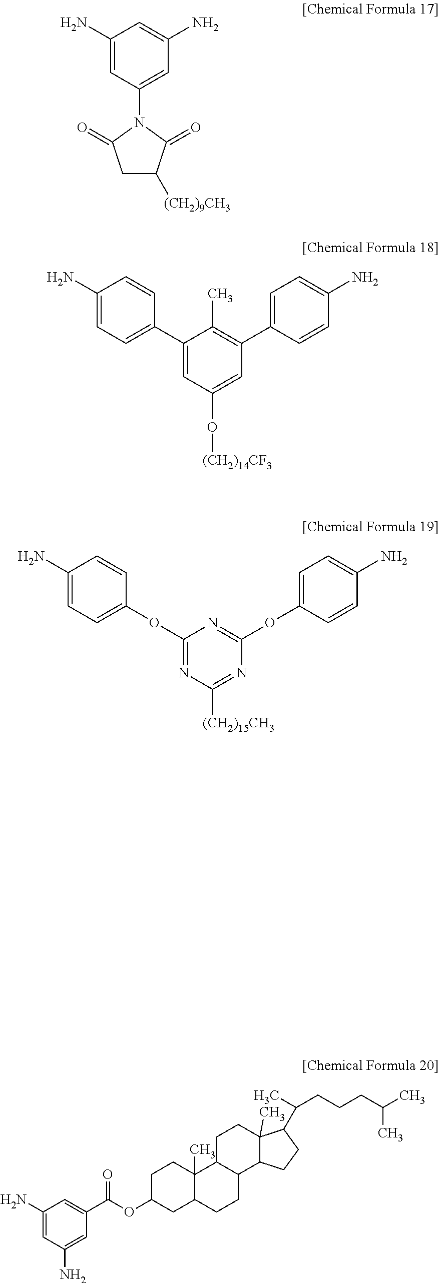

The diamine may include:

at least one diamine represented by the above Chemical Formulas 12 to 16 or a combination thereof;

as the aromatic diamine, paraphenylenediamine (p-PDA), 4,4-methylene dianiline (MDA), 4,4-oxydianiline (ODA), metabisaminophenoxydiphenylsulfone (m-BAPS), parabisaminophenoxydiphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene, or a combination thereof; and

as a functional diamine, at least one diamine represented by the above Chemical Formulas 17 to 20 or a combination thereof.

The diamine may include about 0.05 mol % to about 99 mol % of the diamine represented by the above Chemical Formula 3, about 0.05 mol % to about 99 mol % of the diamine represented by the above Chemical Formula 4, and about 0.05 mol % to about 99 mol % of the diamine represented by the above Chemical Formula 5, based on the total amount (weight) of the diamines.

The aromatic diamine and the functional diamine may be present at a weight ratio of about 1:99 to about 99:1.

The polyamic acid and the polyimide may have a weight average molecular weight of about 10,000 to about 500,000.

The liquid crystal alignment agent may include the polyamic acid and the polyimide at a weight ratio of about 1:99 to about 50:50.

The liquid crystal alignment agent may have a solid content of about 1 wt % to about 25 wt %.

According to another embodiment of the present invention, a liquid crystal alignment film manufactured by applying the liquid crystal alignment agent on a substrate is provided.

The liquid crystal alignment film may be alignable by UV radiation.

According to yet another embodiment of the present invention, a liquid crystal display device including the liquid crystal alignment film is provided.

Hereinafter, further embodiments of the present invention will be described in detail.

The liquid crystal alignment agent may improve transmittance, response speeds, liquid crystal alignment properties, and electro-optical characteristics and easily control a pretilt angle.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” may refer to one substituted with a substituent including halogen (F, Br, Cl or I), a hydroxy group, a nitro group, a cyano group, an amino group (NH₂, NH(R¹⁰⁰) or N(R¹⁰¹)(R¹⁰²), wherein R¹⁰⁰, R¹⁰¹, and R¹⁰² are the same or different and are each independently C1 to C10 alkyl), an amidino group, a hydrazine group, a hydrazone group, a carboxyl group, substituted or unsubstituted alkyl, substituted or unsubstituted haloalkyl, substituted or unsubstituted alkoxy, a substituted or unsubstituted alicyclic organic group, substituted or unsubstituted aryl, substituted or unsubstituted alkenyl, substituted or unsubstituted alkynyl, substituted or unsubstituted heteroaryl, or substituted or unsubstituted heterocycloalkyl instead of at least one hydrogen of a functional group.

As used herein, when a specific definition is not otherwise provided, the term “alkyl” may refer to C1 to C30 alkyl, for example C1 to C20 alkyl, the term “cycloalkyl” may refer to C3 to C30 cycloalkyl, for example C3 to C20 cycloalkyl, the term “heterocycloalkyl” may refer to C2 to C30 heterocycloalkyl, for example C2 to C20 heterocycloalkyl, the term “alkylene” may refer to C1 to C30 alkylene , for example C1 to C20 alkylene, the term “alkoxy” may refer to C1 to C30 alkoxy, for example C1 to C20 alkoxy, the term “cycloalkylene” may refer to C3 to C30 cycloalkylene, for example C3 to C20 cycloalkylene, the term “heterocycloalkylene” may refer to C2 to C30 heterocycloalkylene, for example C2 to C20 heterocycloalkylene, the term “aryl” may refer to C6 to C30 aryl, for example C6 to C20 aryl, the term “heteroaryl” may refer to C2 to C30 heteroaryl, for example C2 to C18 heteroaryl, the term “arylene” may refer to C6 to C30 arylene, for example C6 to C20 arylene, the term “heteroarylene” may refer to C2 to C30 heteroarylene, for example C2 to C20 heteroarylene, the term “alkylaryl” may refer to C7 to C30 alkylaryl, for example C7 to C20 alkylaryl, and the term “halogen” may refer to F, Cl, Br, or I.

As used herein, when a specific definition is not otherwise provided, the terms heterocycloalkyl, heterocycloalkylene, heteroaryl, and heteroarylene may independently refer to cycloalkyl, cycloalkylene, aryl, and arylene, respectively, including 1 to 3 heteroatoms including N, O, S, Si, P or a combination thereof in place of one or more carbon atoms in a ring structure.

As used herein, when a specific definition is not otherwise provided, the term “aliphatic” may refer to C1 to C30 alkyl, C2 to C30 alkenyl, C2 to C30 alkynyl, C1 to C30 alkylene, C2 to C30 alkenylene, or C2 to C30 alkynylene, for example C1 to C20 alkyl, C2 to C20 alkenyl, C2 to C20 alkynyl, C1 to C20 alkylene, C2 to C20 alkenylene, or C2 to C20 alkynylene, the term “alicyclic” may refer to C3 to C30 cycloalkyl, C3 to C30 cycloalkenyl, C3 to C30 cycloalkynyl, C3 to C30 cycloalkylene, C3 to C30 cycloalkenylene, or C3 to C30 cycloalkynylene, for example C3 to C20 cycloalkyl, C3 to C20 cycloalkenyl, C3 to C20 cycloalkynyl, C3 to C20 cycloalkylene, C3 to C20 cycloalkenylene, or C3 to C20 cycloalkynylene, and the term “aromatic” may refer to C5 to C30 aryl, C2 to C30 heteroaryl, C6 to C30 arylene, or C2 to C30 heteroarylene, for example C5 to C16 aryl, C2 to C16 heteroaryl, C6 to C16 arylene, or C2 to C16 heteroarylene. The terms “alicyclic” and “aromatic” may include a fused ring including two or more rings.

As used herein, when a specific definition is not otherwise provided, the term “combination” may refer to mixture or copolymerization; and in the case of an alicyclic organic group and an aromatic organic group, to a fused ring of two or more rings, or two or more rings linked by a single bond, O, S, C(═O), CH(OH), S(═O), S(═O)₂, Si(CH₃)₂, (CH₂)ₚ (wherein, 1≦p≦2), (CF)_{2q} (wherein, 1≦q≦2), C(CH₃)₂, C(CF₃)₂, C(CH₃)(CF₃), or C(═O)NH. Also as used herein, the term “copolymerization” may refer to block copolymerization and/or to random copolymerization, and a “copolymer” may refer to a block copolymer and/or to a random copolymer.

“*” denotes a position linked to the same or different atom or Chemical Formula.

The liquid crystal alignment agent according to one embodiment of the present invention includes a polymer including polyamic acid including a repeating unit represented by the following Chemical Formula 1, polyimide including a repeating unit represented by the following Chemical Formula 2, or a combination thereof.

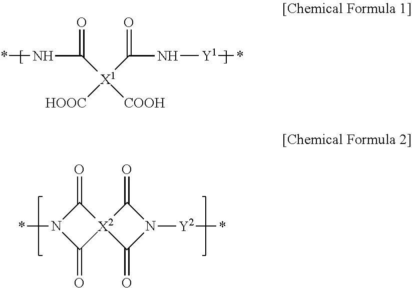

In Chemical Formulas 1 and 2,

X¹ and X² are the same or different and are each independently a tetravalent organic group derived from alicyclic acid dianhydride or aromatic acid dianhydride. X¹ may be the same or different in each repeating unit, and X² may be the same or different in each repeating unit.

Y¹ and Y² are the same or different and are each independently a divalent organic group derived from diamine. The diamine includes at least one diamine represented by the following Chemical Formula 3 and at least one aromatic diamine represented by the following Chemical Formulas 4 to 7 or at least one functional diamine represented by the following Chemical Formulas 8 to 11, or both of at least one aromatic diamine represented by the following Chemical Formulas 4 to 7 and at least one functional diamine represented by the following Chemical Formulas 8 to 11.

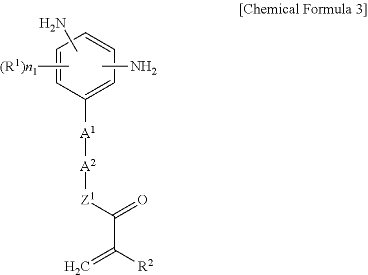

In Chemical Formula 3,

each R¹ is independently hydrogen, a substituted or unsubstituted C1 to C30 aliphatic organic group, or a substituted or unsubstituted C2 to C30 aromatic organic group,

n₁ is an integer ranging from 0 to 3,

A¹ is a divalent organic group represented by —O—, —C(O)O—, —N(H)—, —N(H)C(O)—, —C(O)N(H)—, or —OC(O)—,

A² is a single bond, a substituted or unsubstituted divalent C3 to C30 aliphatic organic group, a substituted or unsubstituted divalent C3 to C30 aromatic organic group, or a substituted or unsubstituted divalent C3 to C30 alicyclic organic group,

Z¹ is a single bond, oxygen (O), a substituted or unsubstituted divalent C1 to C20 aliphatic organic group, a substituted or unsubstituted divalent C2 to C30 aromatic organic group, or a substituted or unsubstituted divalent C3 to C30 alicyclic organic group, and

R² is hydrogen or methyl.

The diamine represented by Chemical Formula 3 includes a residual group derived from acrylate or methacrylate at the terminal end. The residual group derived from acrylate or methacrylate is reacted by photo-radiation. Accordingly, when the diamine represented by Chemical Formula 3 is used to prepare a liquid crystal alignment agent, the liquid crystal alignment agent may promote liquid crystal molecules aligned in one direction during the photo-radiation, effectively improving alignment properties.

In one embodiment, the diamine represented by Chemical Formula 3 may be a diamine of the following Chemical Formulas 12, 13, 14, 15, or 16, and in another embodiment, the diamine may be selected from the following Chemical Formulas 12, 13, 14, 15, and 16, and combinations thereof but is not limited thereto.

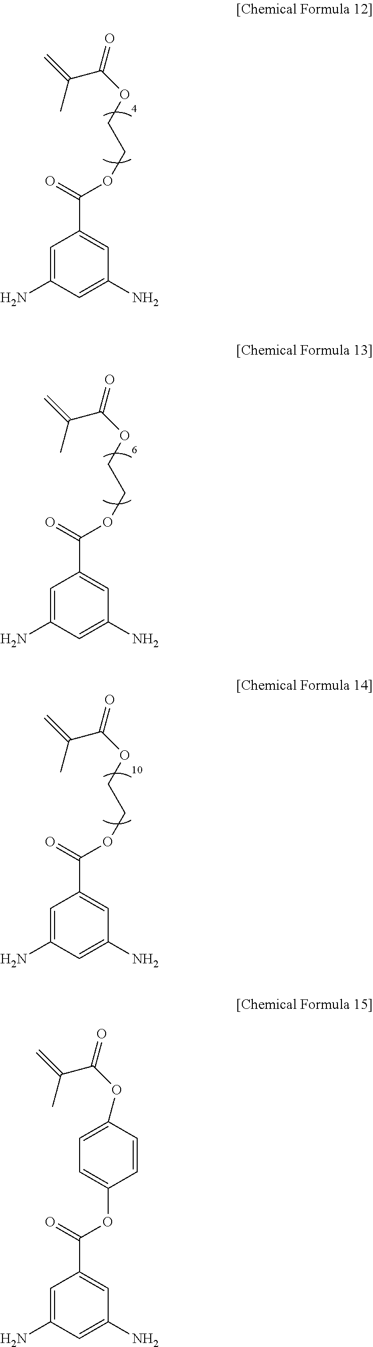

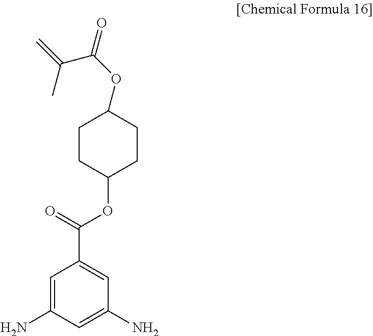 [SMILES: C=C(C)C(=O)OC1CCC(OC(=O)c2cc(N)cc(N)c2)CC1]

The diamine may further include at least one aromatic diamine represented by the following Chemical Formulas 4 to 7 or a combination thereof along with at least one diamine represented by Chemical Formula 3.

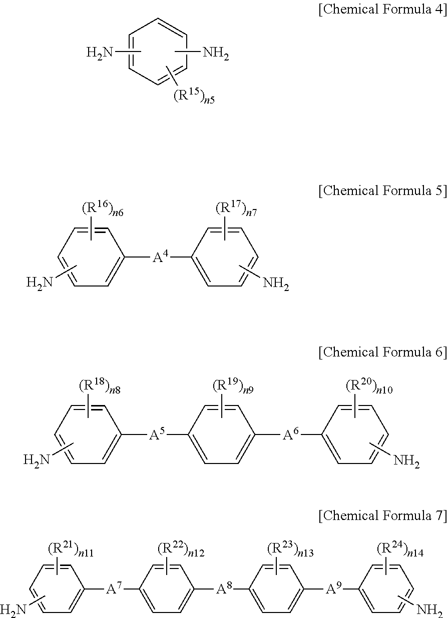

In Chemical Formulas 4 to 7,

R¹⁵ to R²⁴ are the same or different and are each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group, wherein the aliphatic organic group, alicyclic organic group, and aromatic organic group may further include —O—, —C(O)O—, —C(O)N(H)—, —OC(O)—, or a combination thereof,

A⁴ to A⁹ are the same or different and are each independently a single bond, —O—, —S (O)₂— or —C(R¹⁰³)(R¹⁰⁴)—, wherein R¹⁰³ and R¹⁰⁴ are the same or different and are each independently hydrogen or substituted or unsubstituted C1 to C6 alkyl, and

n₅ to n₁₄ are each independently integers ranging from 0 to 4.

When n₅ is an integer of 2 or more, each R¹⁵ may be the same or different from each other. When each n₆ to n₁₄ is 2 or more, each R¹⁶ to R²⁴ may be the same or different from each other.

Examples of the aromatic diamine may include without limitation paraphenylenediamine (p-PDA), 4,4-methylene dianiline (MDA), 4,4-oxydianiline (ODA), metabisaminophenoxydiphenylsulfone (m-BAPS), parabisaminophenoxydiphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene, and the like, and combinations thereof.

The polyamic acid and the polyimide include a divalent organic group derived from the aromatic diamine and may improve chemical resistance, thermal stability, and mechanical properties of a liquid crystal alignment agent and a liquid crystal alignment film fabricated using the same.

The diamine may further include at least one functional diamine represented by the following Chemical Formulas 8 to 11 or a combination thereof along with at least one diamine represented by Chemical Formula 3.

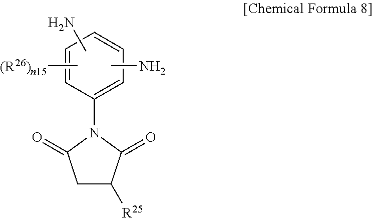

In Chemical Formula 8,

R²⁵ is hydrogen, a substituted or unsubstituted C1 to C30 aliphatic organic group, a substituted or unsubstituted C2 to C30 aromatic organic group, or a substituted or unsubstituted C3 to C30 alicyclic organic group,

each R²⁶ is the same or different and is each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group, and

n₁₅ is an integer ranging from 0 to 3.

When n₁₅ is an integer of 2 or more, each R²⁶ may be the same or different from each other.

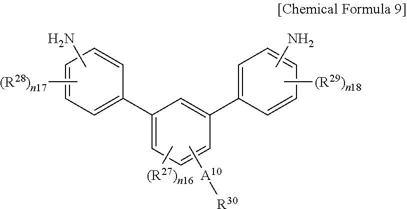

In Chemical Formula 9,

R²⁷, R²⁸, and R²⁹ are the same or different and are each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group,

A¹⁰ is a single bond, —O—, —C(O)O—, —C(O)N(H)—, —OC(O)—, or a substituted or unsubstituted C1 to C10 alkylene group,

R³⁰ is hydrogen, a substituted or unsubstituted C1 to C30 aliphatic organic group, a substituted or unsubstituted C2 to C30 aromatic organic group, or a substituted or unsubstituted C3 to C30 alicyclic organic group, wherein the aliphatic organic group, alicyclic organic group, and aromatic organic group may further include —O—, —C(O)O—, —C(O)N(H)—, —OC(O)—, or a combination thereof,

n₁₆ is an integer of 0 to 3, and

n₁₇ and n₁₈ are each independently an integer ranging from 0 to 4.

When n₁₆ is an integer of 2 or more, each R²⁷ may be the same or different from each other. When each n₁₇ and n₁₈ is 2 or more, each R²⁸ and R²⁹ may be the same or different from each other.

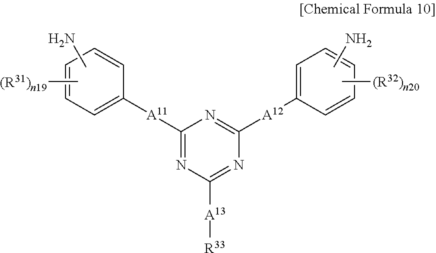

In Chemical Formula 10,

R³¹ and R³² are the same or different and are each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group,

n₁₉ and n₂₀ are each independently an integer ranging from 0 to 4,

R³³ is hydrogen, a substituted or unsubstituted C1 to C30 aliphatic organic group, a substituted or unsubstituted C2 to C30 aromatic organic group, or a substituted or unsubstituted C3 to C30 alicyclic organic group,

A¹¹ and A¹² are the same or different and are each independently a single bond, —O—, or —C(O)O—, and

A¹³ is a single bond, —O—, —C(O)O—, —C(O)N(H)—, or —OC(O)—.

When n₁₉ is an integer of 2 or more, each R³¹ may be the same or different from each other. When n₂₀ is 2 or more, each R³² may be the same or different from one another.

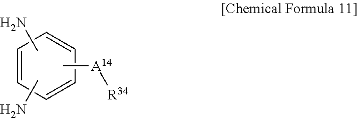

In Chemical Formula 11,

A₁₄ is a divalent organic group represented by —O—, —C(O)—, —C(O)O—, —N(H)—, —N(H)C(O)—, —C(O)N(H)—, —S—, or —OC(O)—,

R³⁴ is hydrogen, a substituted or unsubstituted C1 to C40 aliphatic organic group, a substituted or unsubstituted C2 to C30 aromatic organic group, or a substituted or unsubstituted C1 to C30 alicyclic organic group.

In a functional compound represented by the above Chemical Formula 11, R³⁴ may be a monovalent organic group having a steroid backbone or include 1 to 15 fluorine atom substituents.

Accordingly, the polyamic acid and the polyimide include a divalent organic group derived from the functional diamine and thus, may improve liquid crystal alignment properties, chemical resistance and electro-optical properties and accomplish a high pretilt angle as well as easily adjust a pretilt angle. Therefore, a liquid crystal alignment agent including the polyamic acid and the polyimide may be used to fabricate a vertical alignment liquid crystal alignment film and a twisted nematic liquid crystal alignment film.

The diamine may further include both of at least one of the aromatic diamines represented by the above Chemical Formulas 4 to 7 and at least one of the functional diamines represented by the above Chemical Formulas 8 to 11 along with at least one of the diamines represented by the above Chemical Formula 3.

The diamine may include about 0.05 mol % to about 99 mol % of a diamine represented by the above Chemical Formula 3, about 0.05 mol % to about 99 mol % of a diamine represented by the above Chemical Formula 4, and about 0.05 mol % to about 99 mol % of a diamine represented by the above Chemical Formula 5, wherein the amount of each is based on the total amount of the diamine.

In some embodiments, the diamine may include the diamine represented by Chemical Formula 3 in an amount of about 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 mol %. Further, according to some embodiments of the present invention, the amount of the diamine represented by Chemical Formula 3 can be in a range from about any of the foregoing amounts to about any other of the foregoing amounts.

In some embodiments, the diamine may include the diamine represented by Chemical Formula 4 in an amount of about 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 mol %. Further, according to some embodiments of the present invention, the amount of the diamine represented by Chemical Formula 4 can be in a range from about any of the foregoing amounts to about any other of the foregoing amounts.

In some embodiments, the diamine may include the diamine represented by Chemical Formula 5 in an amount of about 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 mol %. Further, according to some embodiments of the present invention, the amount of the diamine represented by Chemical Formula 5 can be in a range from about any of the foregoing amounts to about any other of the foregoing amounts.

The aromatic diamine and the functional diamine may be present at a weight ratio of about 1:99 to about 99:1. For example, the aromatic diamine and the functional diamine may be included at a weight ratio ranging from about 1:99 to about 80:20, and as another example about 1:99 to about 50:50 in another embodiment.

The combination of the aromatic diamine and the functional diamine may include the aromatic diamine in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the aromatic diamine can be in a range from about any of the foregoing amounts to about any other of the foregoing amounts.

The combination of the aromatic diamine and the functional diamine may include the functional diamine in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the functional diamine can be in a range from about any of the foregoing amounts to about any other of the foregoing amounts.

When each diamine is used in an amount within the above range, it may effectively adjust a pretilt angle and accomplish a high pretilt angle and also, effectively improve liquid crystal alignment property, chemical resistance, electro-optical characteristics, thermal stability, and mechanical characteristic and increase dissolving property and thus, improve processibility.

The polymer may include polyamic acid including a repeating unit represented by the above Chemical Formula 1, polyimide including a repeating unit represented by the above Chemical Formula 2, or a combination thereof.

The polyamic acid including a repeating unit represented by the above Chemical Formula 1 may be synthesized from acid dianhydride and diamine. The method of synthesis of the polyamic acid by copolymerizing the acid dianhydride and the diamine has no particular limit and may include any method known for synthesizing polyamic acid.

The polyimide including a repeating unit represented by the above Chemical Formula 2 may be prepared by imidizing polyamic acid including a repeating unit represented by the above Chemical Formula 1. The imidization of polyamic acid into polyimide is well known in the art and will not be illustrated in detail herein.

The acid dianhydride may include alicyclic acid dianhydride, aromatic acid dianhydride, or a mixture thereof.

The diamine is the same as described above.

Examples of the alicyclic acid dianhydride may include without limitation 1,2,3,4-cyclobutanetetracarboxylic acid dianhydride (CBDA), 5-(2,5-dioxotetrahydropuryl)-3-methylcyclohexene-1,2-dicarboxylic acidanhydride (DOCDA), bicyclooctene-2,3,5,6-tetracarboxylic acid dianhydride (BODA), 1,2,3,4-cyclopentanetetracarboxylic acid dianhydride (CPDA), 1,2,4,5-cyclohexanetetracarboxylic acid dianhydride (CHDA), 1,2,4-tricarboxyl-3-methylcarboxyl cyclopentane dianhydride, 1,2,3,4-tetracarboxyl cyclopentane dianhydride, 2,3,5-tricarboxylcyclopentylacetic acid dianhydride, and the like, and combinations thereof.

Examples of the tetravalent organic group derived from the alicyclic acid dianhydride may include without limitation functional groups represented by the following Chemical Formulas 21 to 25, and combinations thereof.

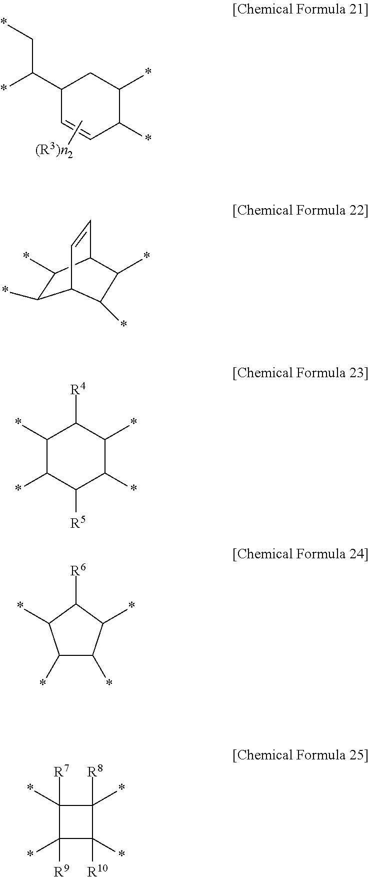

In Chemical Formulas 21 to 25,

each R³ is the same or different and is each independently substituted or unsubstituted C1 to C30 alkyl, substituted or unsubstituted C5 to C30 aryl, or substituted or unsubstituted C2 to C30 heteroaryl,

n₂ is an integer ranging from 0 to 3, and

R⁴ to R¹⁰ are the same or different and are each independently hydrogen, substituted or unsubstituted C1 to C30 alkyl, substituted or unsubstituted C5 to C30 aryl, or substituted or unsubstituted C2 to C30 heteroaryl.

When n₂ is an integer of 2 or more, each R³ may be the same or different from each other.

Examples of the aromatic acid dianhydride may include without limitation pyromellitic acid dianhydride (PMDA), biphthalic acid dianhydride (BPDA), oxydiphthalic acid dianhydride (ODPA), benzophenonetetracarboxylic acid dianhydride (BTDA), hexafluoroisopropylidene diphthalic acid dianhydride (6-FDA), and the like, and combinations thereof.

Examples of the tetravalent organic group derived from the aromatic acid dianhydride may include without limitation functional groups represented by the following Chemical Formulae 26 and 27 and combinations thereof.

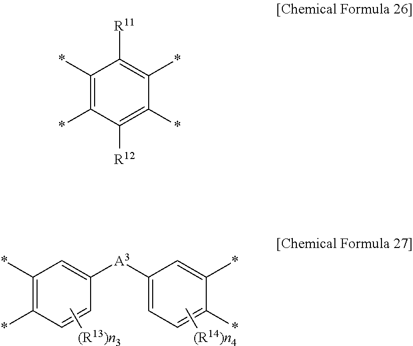

In Chemical Formulas 14 and 15,

R¹¹ and R¹² are the same or different and are each independently, hydrogen, substituted or unsubstituted C1 to C30 alkyl, substituted or unsubstituted C5 to C30 aryl, or substituted or unsubstituted C2 to C30 heteroaryl,

R¹³ and R¹⁴ are the same or different and are each independently substituted or unsubstituted C1 to C30 alkyl, substituted or unsubstituted C5 to C30 aryl, or substituted or unsubstituted C2 to C30 heteroaryl,

n₃ and n₄ are each independently an integer ranging from 0 to 3, and

A³ is a single bond, —O—, —C(O)—, substituted or unsubstituted C1 to C6 alkylene (e.g., C(CF₃)₂), substituted or unsubstituted C3 to C30 cycloalkylene, or substituted or unsubstituted C2 to C30 heterocycloalkylene.

When n₃ is an integer of 2 or more, each R¹³ may be the same or different from each other. When n₄ is an integer of 2 or more, each R¹⁴ may be the same or different from each other.

The polyamic acid may have a weight average molecular weight ranging from about 10,000 to about 500,000.

The polyimide may have a weight average molecular weight ranging from about 10,000 to about 500,000.

When the polyamic acid and polyimide have a weight average molecular weight within the above range, it may effectively improve reliability and electro-optical characteristics and provide excellent chemical resistance and stably maintain a pretilt angle even after driving a liquid crystal display device.

The polyamic acid and the polyimide may be simply mixed or copolymerized with each other.

When the liquid crystal alignment agent includes both the polyamic acid and the polyimide, the polyamic acid and the polyimide may be present at a weight ratio of about 1:99 to about 50:50. For example, the polyamic acid and the polyimide may be present in a weight ratio of about 10:90 to about 50:50.

In some embodiments, the combination of the polyamic acid and the polyimide may include the polyamic acid in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polyamic acid can be in a range from about any of the foregoing amounts to about any other of the foregoing amounts.

In some embodiments, the combination of the polyamic acid and the polyimide may include the polyimide in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polyimide can be in a range from about any of the foregoing amounts to about any other of the foregoing amounts.

When the combination of the polyamic acid and the polyimide includes the polyamic acid and the polyimide in an amount within the above range, alignment stability may be improved.

The liquid crystal alignment agent may include about 1 wt % to about 25 wt %, for example about 3 wt % to about 20 wt %, of the polymer. In some embodiments, the liquid crystal alignment agent may include the polymer in an amount of about 1, 2, 3, 4, 5, 6, 7, 8, 9, 10, 11, 12, 13, 14, 15, 16, 17, 18, 19, 20, 21, 22, 23, 24, or 25 wt %. Further, according to some embodiments of the present invention, the amount of the polymer can be in a range from about any of the foregoing amounts to about any other of the foregoing amounts.

When the liquid crystal alignment agent includes the polymer in an amount within the above range, it may exhibit improved printability and liquid crystal alignment properties.

The liquid crystal alignment agent according to one embodiment of the present invention includes a solvent suitable for dissolving the polymer.

Examples of the solvent suitable for dissolving the polymer may include without limitation N-methyl-2-pyrrolidone; N,N-dimethyl acetamide; N,N-dimethyl formamide; dimethyl sulfoxide; γ-butyrolactone; tetrahydrofuran (THF); phenol-based solvents such as meta cresol, phenol, and halogenated phenols; and the like; and combinations thereof.

The solvent may further include 2-butyl cellosolve (2-BC) to improve printability. The solvent may include 2-butyl cellosolve in amount of about 1 wt % to about 60 wt %, for example about 10 wt % to about 60 wt %, based on the total amount (weight) of the solvent including 2-butyl cellosolve.

In some embodiments, the solvent may include 2-butyl cellosolve in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, or 60 wt %. Further, according to some embodiments of the present invention, the amount of 2-butyl cellosolve can be in a range from about any of the foregoing amounts to about any other of the foregoing amounts.

When 2-butyl cellosolve is included in an amount within the above range, it may easily improve printability.

In addition, the solvent may further include a poor solvent. Examples of the poor solvent include without limitation alcohols, ketones, esters, ethers, hydrocarbons, halogenated hydrocarbons, and the like, and combinations thereof. The poor solvent can be present in an appropriate ratio, as long as the soluble polyimide polymer is not precipitated. The poor solvents may decrease the surface energy of a liquid crystal alignment agent and thus may improve spreadability and flatness during the coating process.

The liquid crystal alignment agent can include the poor solvent in amount of about 1 wt % to about 90 wt %, for example, about 1 wt % to about 70 wt %, based on the total amount (weight) of the solvent including a poor solvent. In some embodiments, the liquid crystal alignment agent can include the poor solvent in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the poor solvent can be in a range from about any of the foregoing amounts to about any other of the foregoing amounts.

Examples of the poor solvent may include without limitation methanol, ethanol, isopropanol, cyclohexanol, ethyleneglycol, propyleneglycol, 1,4-butanediol, triethyleneglycol, acetone, methylethylketone, cyclohexanone, methylacetate, ethylacetate, butylacetate, diethyloxalate, malonic acid ester, diethylether, ethyleneglycol monomethylether, ethyleneglycol dimethylether, ethyleneglycol monoethylether, ethyleneglycol phenylether, ethyleneglycol phenylmethylether, ethyleneglycol phenylethylether, diethyleneglycol dimethylether, diethyleneglycol ether, diethyleneglycol monomethylether, diethyleneglycol monoethylether, diethyleneglycol monomethylether acetate, diethyleneglycol monoethylether acetate, ethyleneglycol methylether acetate, ethyleneglycol ethylether acetate, 4-hydroxy-4-methyl-2-pentanone, 2-hydroxy ethyl propionate, 2-hydroxy-2-methyl ethyl propionate, ethoxy ethyl acetate, hydroxy ethyl acetate, 2-hydroxy-3-methyl methyl butanoate, 3-methoxy methyl propionate, 3-methoxy ethyl propionate, 3-ethoxy ethyl propionate, 3-ethoxy methyl propionate, methyl methoxy butanol, ethyl methoxy butanol, methyl ethoxy butanol, ethyl ethoxy butanol, tetrahydrofuran, dichloromethane, 1,2-dichloroethane, 1,4-dichlorobutane, trichloroethane, chlorobenzene, o-dichlorobenzene, hexane, heptane, octane, benzene, toluene, xylene, and the like, and combinations of more than one.

The amount of solvent included in the liquid crystal alignment agent has no particular limit, but the liquid crystal alignment agent may have a solid content ranging from about 1 to about 25 wt %, for example about 1 wt % to about 20 wt %.

In some embodiments, the liquid crystal alignment agent may have a solid content of about 1, 2, 3, 4, 5, 6, 7, 8, 9, 10, 11, 12, 13, 14, 15, 16, 17, 18, 19, 20, 21, 22, 23, 24, or 25 wt %. Further, according to some embodiments of the present invention, the solid content of the liquid crystal alignment agent can be in a range from about any of the foregoing amounts to about any other of the foregoing amounts.

When the solid content is in an amount within the above range, the liquid crystal alignment agent may be less affected by impurities on the surface of a substrate during the printing and maintain an appropriate viscosity. This may prevent deterioration of the uniformity of a coating layer due to high viscosity and can provide the coating layer with an appropriate transmittance.

The liquid crystal alignment agent may have viscosity of about 2 cps to about 30 cps, for example about 3 cps to about 25 cps, at room temperature. In some embodiments, the liquid crystal alignment agent may have viscosity of about 2, 3, 4, 5, 6, 7, 8, 9, 10, 11, 12, 13, 14, 15, 16, 17, 18, 19, 20, 21, 22, 23, 24, 25, 26, 27, 28, 29, or 30 cps. Further, according to some embodiments of the present invention, the solid content of the liquid crystal alignment agent can be in a range from about any of the foregoing amounts to about any other of the foregoing amounts.

When the liquid crystal alignment agent has a viscosity within the above range, coating uniformity and coating property may be improved.

The liquid crystal alignment agent may further include one or more other additives.

The other additives may include an epoxy compound. The epoxy compound can improve reliability and electro-optical characteristics and may include at least one epoxy compound including 2 to 8 epoxy groups, for example, 2 to 4 epoxy groups.

The liquid crystal alignment agent may include the epoxy in an amount of about 0.1 parts by weight to about 50 parts by weight, for example about 1 part by weight to about 30 parts by weight, based on about 100 parts by weight of the polymer. When the epoxy compound is included in an amount within the above range, printability and flatness may be appropriately realized during coating and the reliability and the electro-optical characteristics may be easily improved.

Examples of the epoxy compound may include without limitation N,N,N′,N′-tetraglycidyl-4,4′-diaminophenylmethane (TGDDM), N,N,N′,N′-tetraglycidyl-4,4′-diaminophenylethane, N,N,N′,N′-tetraglycidyl-4,4′-diaminophenylpropane, N,N,N′,N′-tetraglycidyl-4,4′-diaminophenylbutane, N,N,N′,N′-tetraglycidyl-4,4′-diaminobenzene, ethyleneglycoldiglycidylether, polyethyleneglycoldiglycidylether, propyleneglycoldiglycidylether, tripropyleneglycoldiglycidylether, polypropyleneglycoldiglycidylether, neopentylglycoldiglycidylether, 1,6-hexanedioldiglycidylether, glycerinediglycidylether, 2,2-dibromoneopentylglycoldiglycidylether, 1,3,5,6-tetraglycidyl-2,4-hexanediol, N,N,N′,N′-tetraglycidyl-1,4-phenylenediamine, N,N,N′,N′-tetraglycidyl-m-xylenediamine, N,N,N′,N′-tetraglycidyl-2,2′-dimethyl-4,4′-diaminobiphenyl, 2,2-bis[4-(N,N-diglycidyl-4-aminophenoxy)phenyl]propane, N,N,N′,N′-tetraglycidyl-4,4′-diaminodiphenylmethane, 1,3-bis(N,N-diglycidylaminomethyl)cyclohexane, 1,3-bis(N,N-diglycidylaminomethyl)benzene, and the like and combinations thereof.

In order to improve printability, an additive such as an appropriate surfactant or a coupling agent may be further included.

According to another embodiment, a liquid crystal alignment film formed by using the liquid crystal alignment agent is provided.

The liquid crystal alignment film may be obtained by applying the liquid crystal alignment agent on a substrate. Examples of methods of applying the liquid crystal alignment agent on the substrate may include without limitation spin coating, flexo printing, Inkjet printing and the like. Flexo printing may be generally used, since it can provide excellent coating uniformity and can easily cover a wide area.

The substrate is not specifically limited, as long as it has high transmittance. Examples of the substrate may include without limitation glass substrates, plastic substrates such as acrylic substrates, and polycarbonate substrates, and the like. In addition, a substrate having an indium-tin oxide (ITO) electrode or the like for driving liquid crystals may simplify manufacturing processes.

The liquid crystal alignment agent may be pre-dried at a temperature of room temperature to about 200° C., for example, about 30° C. to about 150° C., or about 40° C. to about 120° C. for about 1 minute to about 100 minutes in order to increase coating uniformity. The pre-drying may allow control of the amount of volatization of each component of the liquid crystal alignment agent and thus can help provide a uniform coating layer having no or minimal deviation.

Then, the coated substrate can be baked at a temperature of about 80° C. to about 300° C., for example, about 120° C. to about 280° C. for about 5 minutes to about 300 minutes to evaporate the solvent in the the liquid crystal alignment agent, providing a liquid crystal alignment film.

The liquid crystal alignment agent may form a pretilt angle through UV radiation as well as rubbing and accordingly, be coated first and then, radiated by UV to initiate the alignment property to form a liquid crystal alignment film.

The UV radiation may be performed by applying a voltage ranging from DC 1 to 100V with energy ranging from about 5 to about 100 J but is not limited thereto.

According to further another embodiment of the present invention, a liquid crystal display device including the liquid crystal alignment film is provided.

Hereinafter, the embodiments are illustrated in more detail with reference to examples. However, the following are exemplary embodiments and are not limiting.

### EXAMPLE

### Synthesis Example 1

### Preparation of 8-(methacryloyloxy)octyl 3,5-diaminobenzoate

### Step1: Preparation of 8-hydroxyoctylmethacrylate

800 mL of methylene chloride is put in a 2 L flask, and 100 g (0.57 mol) of octane-1,8-diol is added thereto and dissolved therein at room temperature under a nitrogen atmosphere. Next, 90 g (1.14 mol) of pyridine is added to the solution. Then, 60 g (0.57 mol) of methacryloylchloride is slowly added to the mixture in a dropwise fashion. When the reaction is complete, the reactant is stored in a refrigerator. After 24 hours storage in a refrigerator, a solid produced therein is filtrated and neutralized with 1N HCl and then separated. The separated organic layer is concentrated and then columnized, obtaining 8-hydroxyoctylmethacrylate with a yield of about 82%.

### Step 2: Preparation of 8-(methacryloxy)octyl-3,5-dinitrobenzoate

400 mL of methylene chloride is put in a 1 L flask, and 44.8 g (0.18 mol) of 8-hydroxyoctylmethacrylate is added thereto and dissolved therein under a nitrogen atmosphere. Next, 22 g (0.28 mol) of pyridine is added to the solution, and 44.8 g (0.19 mol) of 3,5-dinitrobenzoyl chloride is slowly added to the mixture in a dropwise fashion. When the reaction is complete, the reactant is neutralized with 1N HCl and separated. The organic layer is concentrated and columnized, obtaining 8-(methacryloyloxy)octyl-3,5-dinitrobenzoate with a yield of about 66%.

### Step 3: Preparation of 8-(methacryloyloxy)octyl-3,5-diaminobenzoate

200 mL of tetrahydrofuran (THF) is put in a 1 L flask, and 43.6 g (0.1 mol) of 8-(methacryloyloxy)octyl-3,5-dinitrobenzoate is added thereto and dissolved therein under a nitrogen atmosphere. Then, 400 mL of ethanol (EtOH) is added to the solution. Next, 5 equivalents (eq.) of SnCl₂—2H₂O is added to the mixture. The resulting mixture is heated up to 50° C. When the reaction is complete, a 2M NaOH solution is slowly added thereto in a dropwise fashion. When the reaction is complete, the reactant is extracted and concentrated using methylene chloride. The concentrated solution is columnized and separated and then recrystallized under hexane, obtaining 8-(methacryloyloxy)octyl-3,5-diaminobenzoate represented by the following Chemical Formula 12 with a yield of about 52%.

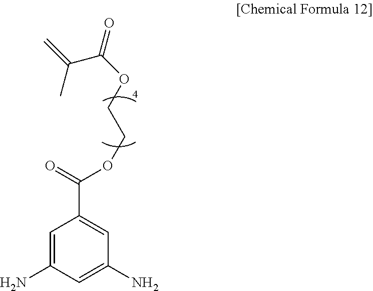

### Example 1

### Preparation of Liquid Crystal Alignment Agent Including polyimide (PSPI-1)

0.79 mol of para-phenylenediamine (p-phenylenediamine), 0.2 mol of 3,5-diaminophenyldecyl succinimide, a functional diamine represented by the following Chemical Formula 17, and 0.01 mol of 8-(methacryloyloxy)octyl-3,5-diaminobenzoate represented by the following Chemical Formula 12 are put in a 4-necked flask with an agitator, a temperature controller, a nitrogen gas injector, and a cooler while nitrogen is passed therethrough, and N-methyl-2-pyrrolidone (NMP) is added thereto, preparing a mixed solution.

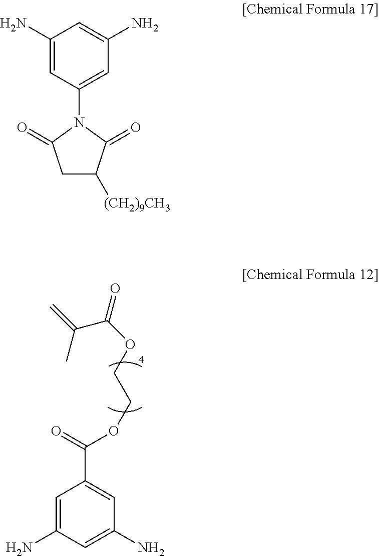

Next, 1.0 mol of 2,3,5-tricarboxylcyclopentylacetic acid dianhydride in a solid state is added to the mixed solution. The mixture is vigorously agitated.

The reactant has a solid content of 20 wt % and is reacted at a temperature ranging from 30° C. to 50° C. for 10 hours. Then, N-methyl-2-pyrrolidone is added to the reactant. The mixture is agitated at a room temperature for 24 hours, preparing a polyamic acid solution.

Then, 3.0 mol of acetic acidanhydride and 5.0 mol of pyridine are added to the polyamic acid solution. The mixture is heated up to 80° C. and reacted for 6 hours and then vacuum distilled to remove catalyst and solvent therein, preparing a polyimide solution having a solid content of 20%. Then, an organic solvent prepared by mixing N-methyl-2-pyrrolidone, γ-butyrolactone, and 2-butylcellosolve in a volume ratio of 50:40:10 is added to the polyimide solution. The mixture is agitated at a room temperature for 24 hours, preparing a liquid crystal alignment agent including polyimide (PSPI-1). The liquid crystal alignment agent has a solid content of 10 wt % and a viscosity of 25 cps at room temperature. In addition, the polyimide (PSPI-1) has a weight average molecular weight of 200,000.

### Example 2

### Preparation of Liquid Crystal Alignment Agent Including polyimide (PSPI-2)

A liquid crystal alignment agent including polyimide (PSPI-2) is prepared according to the same method as Example 1 except for using a functional diamine represented by the following Chemical Formula 18 instead of the functional diamine represented by the above Chemical Formula 17. The liquid crystal alignment agent has a solid content of 10 wt % and a viscosity of 25 cps at room temperature. In addition, the polyimide (PSPI-2) has a weight average molecular weight of 190,000.

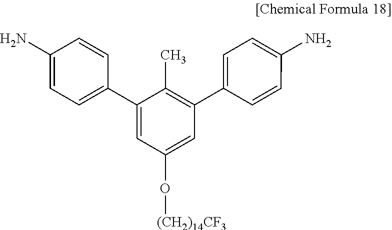

### Example 3

### Preparation of Liquid Crystal Alignment Agent Including polyimide (PSPI-3)

A liquid crystal alignment agent including polyimide (PSPI-3) is prepared according to the same method as Example 1 except for using a functional diamine represented by the following Chemical Formula 19 instead of the functional diamine represented by the above Chemical Formula 17. The liquid crystal alignment agent has a solid content of 10 wt % and a viscosity of 25 cps at room temperature. In addition, the polyimide (PSPI-3) has a weight average molecular weight of 190,000.

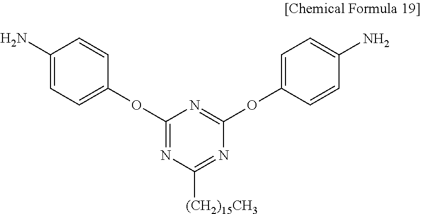

### Example 4

### Preparation of Liquid Crystal Alignment Agent Including polyimide (PSPI-4)

A liquid crystal alignment agent including polyimide (PSPI-4) is prepared according to the same method as Example 1 except for using a functional diamine represented by the following Chemical Formula 20 instead of the functional diamine represented by the above Chemical Formula 17. The liquid crystal alignment agent has a solid content of 10 wt % and a viscosity of 25 cps at room temperature. In addition, the polyimide (PSPI-3) has a weight average molecular weight of 190,000.

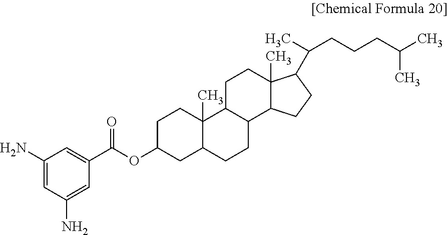 [SMILES: CC(C)CCCC(C)C1CCC2C3CCC4CC(OC(=O)c5cc(N)cc(N)c5)CCC4(C)C3CCC12C]

### Example 5

### Preparation of Liquid Crystal Alignment Agent Including polyimide (PSPI-5)

A liquid crystal alignment agent including polyimide (PSPI-5) was prepared according to the same method as Example 1 except for using 0.5 mol of para-phenylenediamine, 0.2 mol of a functional diamine represented by the above Chemical Formula 17, and 0.3 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-5) has a weight average molecular weight of 200,000.

### Example 6

### Preparation of Liquid Crystal Alignment Agent Including polyimide (PSPI-6)

A liquid crystal alignment agent including polyimide (PSPI-6) is prepared according to the same method as Example 2 except for using 0.5 mol of para-phenylenediamine, 0.2 mol of a functional diamine represented by the above Chemical Formula 18, and 0.3 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-6) has a weight average molecular weight of 210,000.

### Example 7

### Preparation of Liquid Crystal Alignment Agent Including polyimide (PSPI-7)

A liquid crystal alignment agent including polyimide (PSPI-7) is prepared according to the same method as Example 3 except for using 0.5 mol of para-phenylenediamine, 0.2 mol of a functional diamine represented by Chemical Formula 19, and 0.3 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-7) has a weight average molecular weight of 190,000.

### Example 8

### Preparation of Liquid Crystal Alignment Agent Including polyimide (PSPI-8)

A liquid crystal alignment agent including polyimide (PSPI-8) is prepared according to the same method as Example 4 except for using 0.5 mol of para-phenylenediamine, 0.2 mol of a functional diamine represented by Chemical Formula 20, and 0.3 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-8) has a weight average molecular weight of 190,000.

### Example 9

### Preparation of Liquid Crystal Alignment Agent Including polyimide (PSPI-9)

A liquid crystal alignment agent including polyimide (PSPI-9) is prepared according to the same method as Example 1 except for using 0.1 mol of para-phenylenediamine, 0.2 mol of a functional diamine represented by the above Chemical Formula 17, and 0.7 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-9) has a weight average molecular weight of 180,000.

### Example 10

### Preparation of Liquid Crystal Alignment Agent Including polyimide (PSPI-10)

A liquid crystal alignment agent including polyimide (PSPI-10) is prepared according to the same method as Example 2 except for using 0.1 mol of para-phenylenediamine, 0.2 mol of a functional diamine represented by the above Chemical Formula 18, and 0.7 mol of 8-(methacryloyloxy)octyl-3,5-diaminobenzoate. The liquid crystal alignment agent has had a solid content of 10 wt % and a viscosity of 25 cps at room temperature. In addition, the polyimide (PSPI-10) has had a weight average molecular weight of 200,000.

### Example 11

### Preparation of Liquid Crystal Alignment Agent Including polyimide (PSPI-11)

A liquid crystal alignment agent including polyimide (PSPI-11) is prepared according to the same method as Example 3 except for using 0.1 mol of para-phenylenediamine, 0.2 mol of a functional diamine represented by the above Chemical Formula 19, and 0.7 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-11) has a weight average molecular weight of 190,000.

### Example 12

### Preparation of Liquid Crystal Alignment Agent Including polyimide (PSPI-12)

A liquid crystal alignment agent including polyimide (PSPI-12) was prepared according to the same method as Example 4 except for using 0.1 mol of para-phenylenediamine, 0.2 mol of a functional diamine represented by the above Chemical Formula 20, and 0.7 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-12) has a weight average molecular weight of 190,000.

### Example 13

### Preparation of Liquid Crystal Alignment Agent Including polyimide (PSPI-13)

A liquid crystal alignment agent including polyimide (PSPI-13) is prepared according to the same method as Example 1 except for using 0.05 mol of para-phenylenediamine, 0.05 mol of a functional diamine represented by the above Chemical Formula 17, and 0.9 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-13) has a weight average molecular weight of 200,000.

### Example 14

### Preparation of Liquid Crystal Alignment Agent Including polyimide (PSPI-14)

A liquid crystal alignment agent including polyimide (PSPI-14) is prepared according to the same method as Example 2 except for using 0.05 mol of para-phenylenediamine, 0.05 mol of a functional diamine represented by the above Chemical Formula 18, and 0.9 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-14) has a weight average molecular weight of 190,000.

### Example 15

### Preparation of Liquid Crystal Alignment Agent Including polyimide (PSPI-15)

A liquid crystal alignment agent including polyimide (PSPI-15) is prepared according to the same method as Example 3 except for using 0.05 mol of para-phenylenediamine, 0.05 mol of a functional diamine represented by the above Chemical Formula 19, and 0.9 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-15) has a weight average molecular weight of 210,000.

Example 16

### Preparation of Liquid Crystal Alignment Agent Including polyimide (PSPI-16)

A liquid crystal alignment agent including polyimide (PSPI-15) is prepared according to the same method as Example 3 except for using 0.05 mol of para-phenylenediamine, 0.05 mol of a functional diamine represented by the above Chemical Formula 20, and 0.9 mol of 8-(methacryloyloxy)octyl-3,5-diaminobenzoate. The liquid crystal alignment agent has a solid content of 10 wt % and a viscosity of 25 cps at room temperature. In addition, the polyimide (PSPI-16) has a weight average molecular weight of 210,000.

### Example 17

### Preparation of Liquid Crystal Alignment Agent Including polyimide (PSPI-17)

A liquid crystal alignment agent including polyimide (PSPI-17) is prepared according to the same method as Example 12 except for using a compound represented by the following Chemical Formula 15 instead of 8-(methacryloyloxy)octyl-3,5-diaminobenzoate. The liquid crystal alignment agent has a solid content of 10 wt % and a viscosity of 25 cps at room temperature. In addition, the polyimide (PSPI-17) had a weight average molecular weight of 190,000.

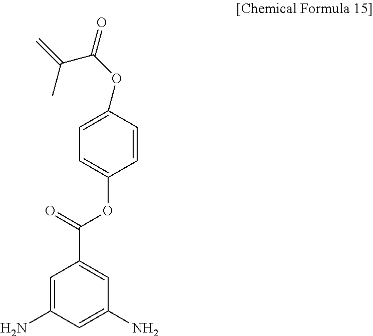 [SMILES: C=C(C)C(=O)Oc1ccc(OC(=O)c2cc(N)cc(N)c2)cc1]

### Example 18

### Preparation of Liquid Crystal Alignment Agent Including polyimide (PSPI-18)

A liquid crystal alignment agent including polyimide (PSPI-18) is prepared according to the same method as Example 12 except for using a compound represented by the above Chemical Formula 16 instead of 8-(methacryloyloxy)octyl-3,5-diaminobenzoate. The liquid crystal alignment agent has a solid content of 10 wt % and a viscosity of 25 cps at room temperature. In addition, the polyimide (PSPI-18) has a weight average molecular weight of 190,000.

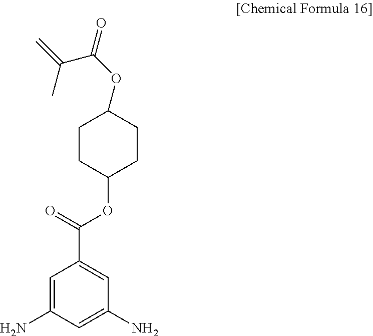 [SMILES: C=C(C)C(=O)OC1CCC(OC(=O)c2cc(N)cc(N)c2)CC1]

### Comparative Example 1

### Preparation of Liquid Crystal Alignment Agent Including polyimide (PSPI-19)

A liquid crystal alignment agent including polyimide (PSPI-19) is prepared according to the same method as Example 1 except for using 0.8 mol of para-phenylenediamine and 0.2 mol of a functional diamine represented by the above Chemical Formula 17 but no 8-(methacryloyloxy)octyl-3,5-diaminobenzoate. The liquid crystal alignment agent has a solid content of 10 wt % and a viscosity of 25 cps at room temperature. In addition, the polyimide (PSPI-19) has a weight average molecular weight of 190,000.

### Comparative Example 2

### Preparation of Liquid Crystal Alignment Agent Including polyimide (PSPI-20)

A liquid crystal alignment agent including polyimide (PSPI-20) is prepared according to the same method as Example 2 except for using 0.8 mol of para-phenylenediamine and 0.2 mol of a functional diamine represented by the above Chemical Formula 18 but no 8-(methacryloyloxy)octyl-3,5-diaminobenzoate. The liquid crystal alignment agent has a solid content of 10 wt % and a viscosity of 25 cps at room temperature. In addition, the polyimide (PSPI-20) has a weight average molecular weight of 200,000.

### Comparative Example 3

### Preparation of Liquid Crystal Alignment Agent Including polyimide (PSPI-21)

A liquid crystal alignment agent including polyimide (PSPI-21) is prepared according to the same method as Example 3 except for using 0.8 mol of para-phenylenediamine and 0.2 mol of a functional diamine represented by the above Chemical Formula 19 but no 8-(methacryloyloxy)octyl-3,5-diaminobenzoate. The liquid crystal alignment agent has a solid content of 10 wt % and a viscosity of 25 cps at room temperature. In addition, the polyimide (PSPI-21) has a weight average molecular weight of 210,000.

### Comparative Example 4

### Preparation of Liquid Crystal Alignment Agent Including polyimide (PSPI-22)

A liquid crystal alignment agent including polyimide (PSPI-22) is prepared according to the same method as Example 3 except for using 0.8 mol of para-phenylenediamine and 0.2 mol of a functional diamine represented by the above Chemical Formula 20 but no 8-(methacryloyloxy)octyl-3,5-diaminobenzoate. The liquid crystal alignment agent has a solid content of 10 wt % and a viscosity of 25 cps at room temperature. In addition, the polyimide (PSPI-22) has a weight average molecular weight of 210,000.

### Comparative Example 5

### Preparation of Liquid Crystal Alignment Agent Including polyimide (PSPI-23)

A liquid crystal alignment agent including polyimide (PSPI-23) is prepared according to the same method as Example 1 except for using 1.0 mol of 8-(methacryloyloxy)octyl-3,5-diaminobenzoate but no para-phenylenediamine (p-phenylenediamine) and 3,5-diaminophenyloctadecyl succinimide, which is a functional diamine represented by the above Chemical Formula 17. The liquid crystal alignment agent has a solid content of 10 wt % and a viscosity of 25 cps at room temperature. In addition, the polyimide (PSPI-23) has a weight average molecular weight of 190,000.

### Comparative Example 6

### Preparation of Liquid Crystal Alignment Agent Including polyimide (PSPI-24)

A liquid crystal alignment agent including polyimide (PSPI-24) is prepared according to the same method as Example 17 except for using 0.8 mol of para-phenylenediamine and 0.2 mol of a functional diamine represented by the above Chemical Formula 20 but no diamine represented by the above Chemical Formula 15. The liquid crystal alignment agent has a solid content of 10 wt % and a viscosity of 25 cps at room temperature. In addition, the polyimide (PSPI-24) has a weight average molecular weight of 190,000.

### Comparative Example 7

### Preparation of Liquid Crystal Alignment Agent Including polyimide (PSPI-25)

A liquid crystal alignment agent including polyimide (PSPI-25) is prepared according to the same method as Example 18 except for using 0.8 mol of para-phenylenediamine and 0.2 mol of a functional diamine represented by the above Chemical Formula 20 but no diamine represented by the above Chemical Formula 16. The liquid crystal alignment agent has a solid content of 10 wt % and a viscosity of 25 cps at room temperature. In addition, the polyimide (PSPI-25) has a weight average molecular weight of 190,000.

### Experimental Example 1

### Evaluation of Vertical Alignment Properties of Liquid Crystal Alignment Film (Measuring the Pretilt Angle Difference (Pretilt Angle) from the Standard Liquid Crystal Cell) and Electro-Optical Characteristics

Liquid crystal cells are fabricated to evaluate vertical alignment properties of the liquid crystal alignment agents. The liquid crystal cells are fabricated as follows.

A standardized ITO glass substrate is patterned through photolithography to remove the rest of indium-tin oxide (ITO) except for a 3 cm×6 cm ITO shape and an ITO electrode shape for voltage application thereon.

Then, the liquid crystal alignment agents of Examples 1 to 16 and Comparative Examples 1 to 5 respectively are spin-coated to be 0.1 μm thick on the patterned ITO substrate and cured at a temperature of 80° C. and 220° C.

Next, spacers are distributed on one substrate, while a sealant is coated on another substrate. These two substrates are hot-pressed and assembled to maintain a cell gap of about 3.25 μm. Then, a liquid crystal for a VA mode is injected into an empty cell using capillary action. The cell is sealed with a UV hardening bond for end-sealing, fabricating a liquid crystal cell for a test.

The vertical alignment properties of the liquid crystal cells are observed using a perpendicularly polarized optical microscope. After observing the vertical alignment properties, one liquid crystal cell having good vertical alignment properties is selected as a standard liquid crystal cell, and the pretilt angle of the standard liquid crystal cell is designated as 90°. Then, each liquid crystal cell is radiated with UV energy while applying an electric field and measured about a pretilt angle in a crystal rotation method. In Table 1, pretilt indicates a difference between the measured pretilt angle of each liquid crystal cell and the pretilt angle of the standard liquid crystal cell.

In addition, a voltage of 1V is applied to the obtained liquid crystal cells and voltage holding ratio (VHR) is measured depending on a temperature; and a voltage of −10V to +10V is applied to each liquid crystal cell and residual DC (RDC) voltage is measured.

The voltage holding ratio indicates the degree that a liquid crystal layer floated with extraneous power for a non-elected period maintains a charged voltage in TFT-LCD having an active matrix mode. It is preferable that the voltage holding ratio approaches 100%.

The residual DC voltage indicates voltage applied to a liquid crystal layer, since an alignment film adsorbs impurities in the liquid crystal layer as the liquid crystal layer becomes ionized, in which the lower is the better. The residual DC voltage in generally measured in a method using a flicker and an electrical capacity change curved line (C-V) of a liquid crystal layer depending upon a DC voltage.

### Experimental Example 2

### Evaluation of Light Transmittance

A liquid crystal cell is fabricated according to the method of Experimental Example 1.

A voltage of DC 30V is applied to the liquid crystal cell and then the liquid crystal cell is photo-radiated with 20 J energy to align liquid crystals on the surface of a liquid crystal alignment film in a desired direction.

A voltage of AC 6.5V is applied to each liquid crystal cell and the amount of transmitted light is measured. Assuming that each liquid crystal cell fabricated using the liquid crystal alignment agents according to Comparative Examples 1 to 5 respectively transmits 100% of light ranging from 400 nm to 750 nm, the amount of transmitted light ranging from about 400 nm to about 750 nm is measured for the liquid crystal cells fabricated using the liquid crystal alignment agents according to Examples 1 to 16 respectively and compared with those of Comparative Examples 1 to 5. The results are provided in the following Table 1.

### Experimental Example 3

### Evaluation of Response Speed

Each liquid crystal test cell according to Experimental Example 1 is alternatively applied with AC 6.5V and AC 0.1V and transmittance change is measured using an oscilloscope (when each liquid crystal test cell is applied with a voltage of AC 6.5V, its transmittance increased from 0% to 100, while when it is applied with a voltage of AC 0.1V, its transmittance decreased from 100% to 0%). In general, the response speed of a liquid crystal cell is calculated by summing how long it takes for transmittance to increase from 10% to 90% (rising time, Tₒₙ) and how long it takes for transmittance to decrease from 90% to 10% (falling time, T_{off}). However, only the rising time (Tₒₙ) is measured and compared in this specification. The results are provided in the following Table 1.

### Experimental Example 4

### Evaluation of Printability and Chemical Resistance

The liquid crystal alignment agents according to Examples 1 to 16 and Comparative Examples 1 to 5 respectively are flexo-printed on a glass substrate to which a clean ITO is attached using an alignment film printer (CZ 200®, Nakan). The printed substrate is allowed to stand on a hot plate at a temperature ranging from 50 to 90° C. for 2 to 5 minutes and then predried.

After the predrying of the substrate, the substrate is fired on a hot plate at a temperature ranging from 200 to 230° C. for 10 to 30 minutes and evaluated for printability (pinhole and stain) of a liquid crystal alignment film on the front side (middle and end parts) of the substrate with the bare eye and an electron microscope (MX50®, Olympus Co.). The results are provided in the following Table 1.

In the following Table 1, printability is evaluated by the number of pin holes and stain; 0-3 pinholes are regarded as good, 3-5 pinholes average, and more than 6 pinholes bad, and no stain is regarded as good while stains are regarded as bad. Film uniformity is evaluated to be good when a thickness deviation is smaller than 0.005 μm, average when a thickness deviation ranges from 0.005 to 0.01 μm, and bad when a thickness deviation is greater than 0.01 μm.

In addition, chemical resistance is evaluated by dipping the substrate fired on a hot plate at a temperature ranging from 200 to 230° C. for 10 to 30 minutes in IPA (iso-propylalchol). The results are provided in the following Table 1.

In the following Table 1, chemical resistance is evaluated. A liquid crystal cell according to the same method as Experimental Example 1 is fabricated after dipping a coated substrate in IPA for 30 seconds and drying it, and then the vertical alignment property of the liquid crystal cell is observed using a perpendicularly polarized optical microscope. In Table 1, good vertical alignment properties are regarded as good chemical resistance, while bad vertical alignment properties are regarded as bad chemical resistance.

TABLE 1

| | | | | | | Response | | |
|---|---|---|---|---|---|---|---|---|
| | Vertical | Voltage | Residual | Pretilt | Light | speed | | |
| | alignment | holding | DC | angle | transmittance | (rising, | | Chemical |
| Samples | properties | ratio (%) | (mV) | (°) | (%) | ms) | Printability | resistance |
| Example 1 | Good | 99.1 | 38 | 0.68 | 109 | 14 | Good | Good |
| Example 2 | Good | 99.0 | 42 | 0.64 | 106 | 16 | Good | Good |
| Example 3 | Good | 98.9 | 46 | 0.57 | 104 | 17 | Good | Good |
| Example 4 | Good | 99.1 | 38 | 0.65 | 105 | 16 | Good | Good |
| Example 5 | Good | 99.0 | 41 | 0.79 | 114 | 12 | Good | Good |
| Example 6 | Good | 98.8 | 46 | 0.72 | 109 | 14 | Good | Good |
| Example 7 | Good | 98.7 | 38 | 0.73 | 109 | 13 | Good | Good |
| Example 8 | Good | 98.9 | 49 | 0.73 | 110 | 12 | Good | Good |
| Example 9 | Good | 98.9 | 47 | 0.96 | 116 | 9 | Good | Good |
| Example | Good | 99.0 | 44 | 0.93 | 111 | 11 | Good | Good |
| 10 | | | | | | | | |
| Example | Good | 98.9 | 39 | 0.91 | 112 | 11 | Good | Good |
| 11 | | | | | | | | |
| Example | Good | 99.0 | 45 | 0.94 | 114 | 10 | Good | Good |
| 12 | | | | | | | | |
| Example | Good | 99.0 | 42 | 1.04 | 121 | 6 | Good | Good |
| 13 | | | | | | | | |
| Example | Good | 98.9 | 42 | 1.01 | 114 | 10 | Good | Good |
| 14 | | | | | | | | |
| Example | Good | 98.9 | 46 | 0.98 | 115 | 10 | Good | Good |
| 15 | | | | | | | | |
| Example | Good | 98.9 | 37 | 1.00 | 117 | 8 | Good | Good |
| 16 | | | | | | | | |
| Example | Good | 98.9 | 52 | 0.72 | 107 | 16 | Good | Good |
| 17 | | | | | | | | |
| Example | Good | 98.9 | 55 | 0.66 | 105 | 18 | Good | Good |
| 18 | | | | | | | | |
| Comparative | Good | 98.8 | 48 | 0.0 | 100 | 25 | Good | Good |
| Example 1 | | | | | | | | |
| Comparative | Good | 98.9 | 50 | 0.0 | 100 | 25 | Good | Good |
| Example 2 | | | | | | | | |
| Comparative | Good | 98.8 | 46 | 0.0 | 100 | 25 | Good | Good |
| Example 3 | | | | | | | | |
| Comparative | Good | 98.8 | 47 | 0.0 | 100 | 25 | Good | Good |
| Example 4 | | | | | | | | |
| Comparative | Good | 96.9 | 96 | 2.9 | 118 | 8 | Bad | Bad |
| Example 5 | | | | | | | | |
| Comparative | Good | 98.8 | 58 | 0.0 | 100 | 25 | Good | Good |
| Example 6 | | | | | | | | |
| Comparative | Good | 98.7 | 60 | 0.0 | 100 | 25 | Good | Good |
| Example 7 | | | | | | | | |

As shown in Table 1, the liquid crystal alignment agents according to Examples 1 to 18 have excellent vertical alignment and liquid crystal alignment properties and excellent electric characteristic and thus may be effectively used to form a liquid crystal alignment film.

In addition, the liquid crystal alignment agents should have the pretilt angle value within an appropriate range to be effectively used for a liquid crystal alignment film. As shown in the Table 1, each liquid crystal cell fabricated using the liquid crystal alignment agents according to Examples 1 to 18 has pretilt angle ranging from 0.55 to 1.05 degrees after the photo-radiation and thus, good liquid crystal alignment property compared with each liquid crystal cell fabricated using the liquid crystal alignment agents according to Comparative Examples 1 to 7. On the contrary, the liquid crystal alignment agents according to Comparative Examples 1 to 4 and 6 to 7 have no pretilt angle and thus, bad liquid crystal alignment properties. The liquid crystal alignment agent according to Comparative Example 5 has too high a pretilt, whose excessive pretilt angle difference may deteriorate vertical alignment and thus generate light leakage.

In addition, the liquid crystal cells fabricated by using the liquid crystal alignment agents according to Examples 1 to 18 have about 5% to 20% more improved light transmittance than the liquid crystal cells fabricated by using the liquid crystal alignment agents according to Comparative Examples 1 to 4 and 6 to 7. Furthermore, the liquid crystal cells fabricated by using the liquid crystal alignment agents according to Examples 1 to 18 have about 10 ms to 20 ms more improved response speed than the liquid crystal cells fabricated by using the liquid crystal alignment agents according to Comparative Examples 1 to 4 and 6 to 7.

Particularly, the liquid crystal cells fabricated by using the liquid crystal alignment agents according to Examples 1 to 18 are identified to maintain a balance of vertical alignment properties and response speed due to pretilt angle difference.

In addition, the liquid crystal alignment agent according to Comparative Example 5 has good light transmittance and response speed but bad printability and chemical resistance.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A liquid crystal alignment agent, comprising:
a polymer comprising polyamic acid including a repeating unit represented by the following Chemical Formula 1, polyimide including a repeating unit represented by the following Chemical Formula 2, or a combination thereof: 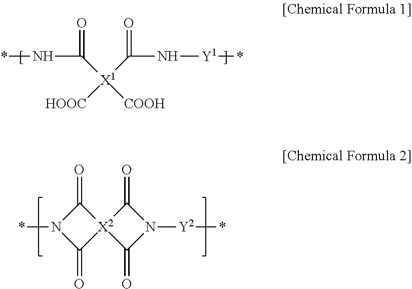
wherein, in Chemical Formulas 1 and 2,
X¹ and X² are the same or different and are each independently a tetravalent organic group derived from alicyclic acid dianhydride or aromatic acid dianhydride,
Y¹ and Y² are the same or different and are each independently a divalent organic group derived from diamine, wherein the diamine includes at least one diamine represented by the following Chemical Formula 3 and at least one aromatic diamine represented by the following Chemical Formulas 4 to 7 or at least one functional diamine represented by the following Chemical Formulas 8 to 11, or both of at least one aromatic diamine represented by the following Chemical Formulas 4 to 7 and at least one functional diamine represented by the following Chemical Formulas 8 to 11: 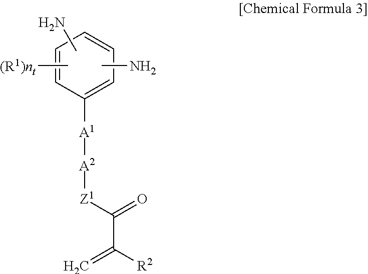
wherein, in Chemical Formula 3,
each R¹ is independently hydrogen, a substituted or unsubstituted C1 to C30 aliphatic organic group, or a substituted or unsubstituted C2 to C30 aromatic organic group,
n₁ is an integer ranging from 0 to 3,
A¹ is a divalent organic group represented by —O—, —C(O)O—, —N(H)—, —N(H)C(O)—, —C(O)N(H)—, or —OC(O)—,
A² is a single bond, a substituted or unsubstituted divalent C3 to C30 aliphatic organic group, a substituted or unsubstituted divalent C3 to C30 aromatic organic group, or a substituted or unsubstituted divalent C3 to C30 alicyclic organic group,
Z¹ is a single bond, oxygen (O), a substituted or unsubstituted divalent C1 to C20 aliphatic organic group, a substituted or unsubstituted divalent C2 to C30 aromatic organic group, or a substituted or unsubstituted divalent C3 to C30 alicyclic organic group, and
R² is hydrogen or methyl: 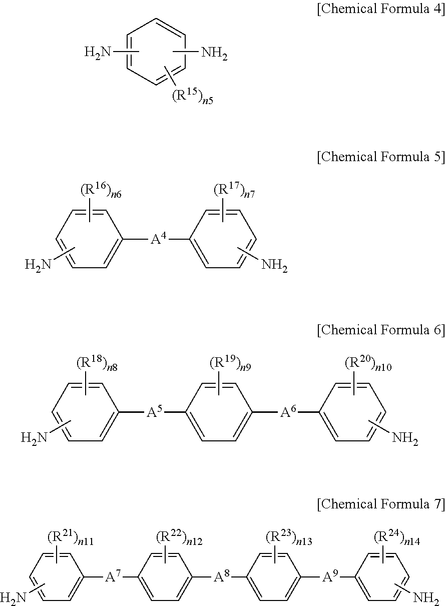
wherein in Chemical Formulas 4 to 7,
R¹⁵ to R²⁴ are the same or different and are each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group, wherein the aliphatic organic group, alicyclic organic group, and aromatic organic group optionally further includes —O—, —C(O)O—, —C(O)N(H)—, —OC(O)—, or a combination thereof,
A⁴ to A⁹ are the same or different and are each independently a single bond, —O—, —S (O)₂— or —C(R¹⁰³)(R¹⁰⁴)—, wherein R¹⁰³ and R¹⁰⁴ are the same or different and are each independently hydrogen or substituted or unsubstituted C1 to C6 alkyl, and
n₅ to n₁₄ are each independently integers ranging from 0 to 4: 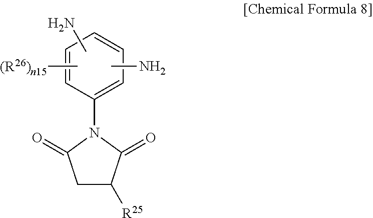
wherein in Chemical Formula 8,
R²⁵ is hydrogen, a substituted or unsubstituted C1 to C30 aliphatic organic group, a substituted or unsubstituted C2 to C30 aromatic organic group, or a substituted or unsubstituted C3 to C30 alicyclic organic group,
each R²⁶ is the same or different and is each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group, and
n₁₅ is an integer ranging from 0 to 3: 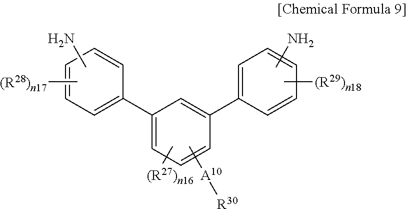
wherein in Chemical Formula 9,
R²⁷, R²⁸, and R²⁹ are the same or different and are each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group,
A¹⁰ is a single bond, —O—, —C(O)O—, —C(O)N(H)—, —OC(O)—, or substituted or unsubstituted C1 to C10 alkylene,
R³⁰ is hydrogen, a substituted or unsubstituted C1 to C30 aliphatic organic group, a substituted or unsubstituted C2 to C30 aromatic organic group, or a substituted or unsubstituted C3 to C30 alicyclic organic group, wherein the aliphatic organic group, alicyclic organic group, and aromatic organic group optionally further includes —O—, —C(O)O—, —C(O)N(H)—, —OC(O)—, or a combination thereof,
n₁₆ is an integer of 0 to 3, and
n₁₇ and n₁₈ are each independently an integer ranging from 0 to 4: 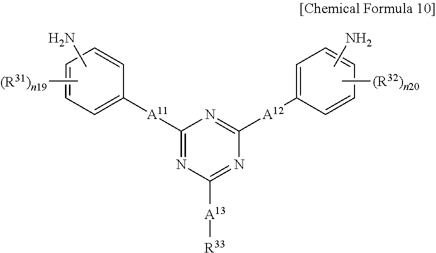
wherein in Chemical Formula 10,
R³¹ and R³² are the same or different and are each independently, hydrogen, a substituted or unsubstituted C1 to C30 aliphatic organic group, a substituted or unsubstituted C2 to C30 aromatic organic group, or a substituted or unsubstituted C3 to C30 alicyclic organic group,
n₁₉ and n₂₀ are each independently an integer ranging from 0 to 4,
R³³ is hydrogen, a substituted or unsubstituted C1 to C30 aliphatic organic group, a substituted or unsubstituted C2 to C30 aromatic organic group, or a substituted or unsubstituted C3 to C30 alicyclic organic group,
A¹¹ and A¹² are the same or different and are each independently a single bond, —O—, or —C(O)O—, and
A¹³ is a single bond, —O—, —C(O)O—, —C(O)N(H)—, or —OC(O)—: 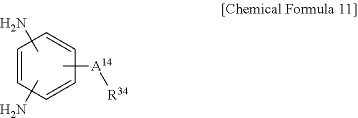
wherein in Chemical Formula 11,
A₁₄ is a divalent organic group represented by —O—, —C(O)—, —C(O)O—, —N(H)—, —N(H)C(O)—, —C(O)N(H)—, —S—, or —OC(O)—, and
R³⁴ is hydrogen, a substituted or unsubstituted C1 to C40 aliphatic organic group, a substituted or unsubstituted C2 to C30 aromatic organic group, or a substituted or unsubstituted C1 to C30 alicyclic organic group.

2. The liquid crystal alignment agent of claim 1, wherein the diamine represented by Chemical Formula 3 is a compound represented by the following Chemical Formulas 12 to 16 or a combination thereof:

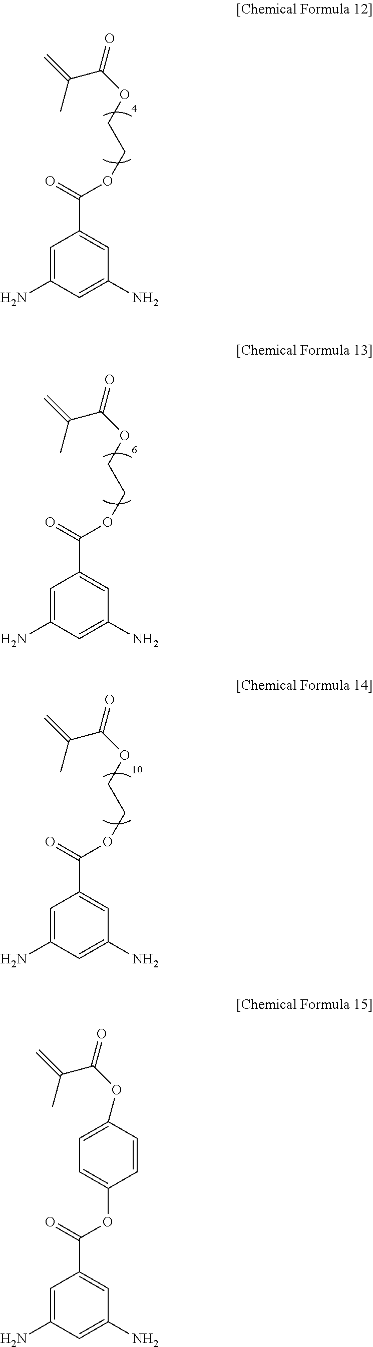

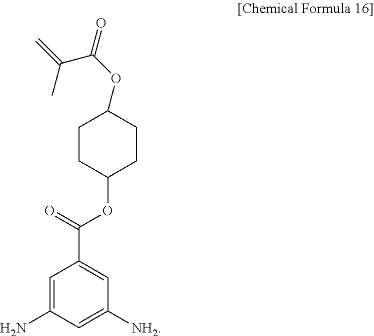 [SMILES: C=C(C)C(=O)OC1CCC(OC(=O)c2cc(N)cc(N)c2)CC1]

3. The liquid crystal alignment agent of claim 1, wherein the aromatic diamine is paraphenylenediamine (p-PDA), 4,4-methylene dianiline (MDA), 4,4-oxydianiline (ODA), metabisaminophenoxydiphenylsulfone (m-BAPS), parabisaminophenoxydiphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene, or a combination thereof.

4. The liquid crystal alignment agent of claim 1, wherein the functional diamine is a diamine represented by the following Chemical Formulas 17 to 20 or a combination thereof:

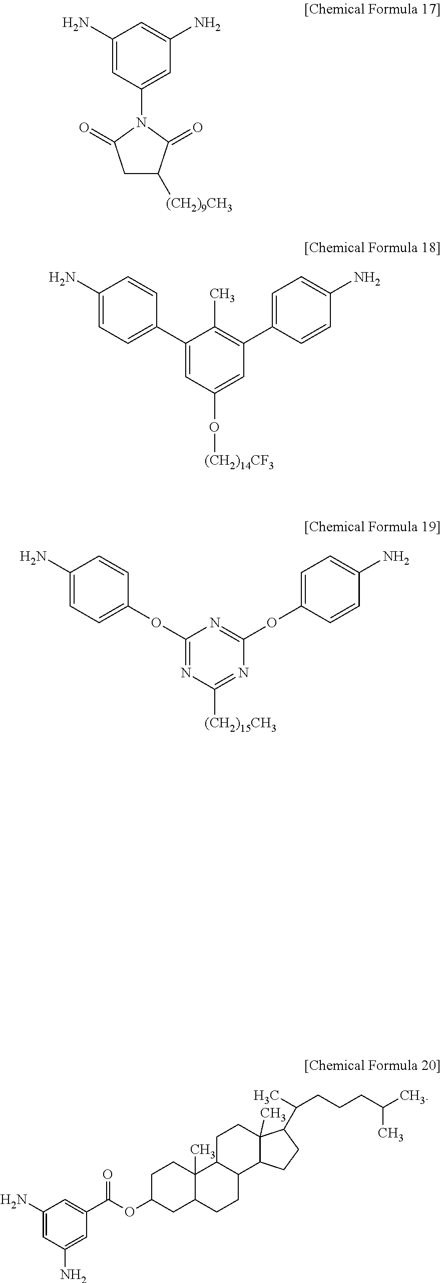

5. The liquid crystal alignment agent of claim 1, wherein the diamine comprises about 0.05 mol % to about 99 mol % of diamine represented by Chemical Formula 3, about 0.05 mol % to about 99 mol % of diamine represented by Chemical Formula 4, and about 0.05 mol % to about 99 mol % of diamine represented by Chemical Formula 5 based on the total amount of diamine.

6. The liquid crystal alignment agent of claim 1, wherein the aromatic diamine and the functional diamine are present at a weight ratio of about 1:99 to about 99:1.

7. The liquid crystal alignment agent of claim 1, wherein the polyamic acid and the polyimide have a weight average molecular weight of about 10,000 to about 500,000.

8. The liquid crystal alignment agent of claim 1, wherein the liquid crystal alignment agent comprises the polyamic acid and the polyimide at a weight ratio of about 1:99 to about 50:50.

9. The liquid crystal alignment agent of claim 1, wherein the liquid crystal alignment agent has a solid content of about 1 wt % to about 25 wt %.

10. A liquid crystal alignment film manufactured by applying the liquid crystal alignment agent of claim 1.

11. A liquid crystal display device comprising the liquid crystal alignment film of claim 10.
